(19) United States
(12) Patent Application Publication
(10) Pub. No.: US 2025/0138154 A1
(43) Pub. Date: May 1, 2025

(54) OPTICAL SENSOR MODULE

(71) Applicant: STMicroelectronics International N.V., Geneva (CH)

(72) Inventors: Yandong MAO, Shanghai (CN); Kai Quan CHENG, Singapore (SG); Tat Ming TEO, Singapore (SG); Fraser WILLIAMS, Edinburgh (GB); Dominique NUYTS, ST EGREVE (FR)

(21) Appl. No.: 18/915,086

(22) Filed: Oct. 14, 2024

(30) Foreign Application Priority Data
Oct. 25, 2023 (FR) 2311604

(51) Int. Cl. G01S 7/481; G01S 17/08

(52) U.S. Cl. CPC G01S 7/4813; G01S 17/08

(57) ABSTRACT

The present disclosure provides an optical sensor module. An example optical sensor module comprises: a light-emitting device; a light-receiving sensor; and a module cap adapted to at least partially cover the light-emitting device and the light-receiving sensor, the module cap comprising a metal casing and a molded part made of a molding material lining the inside surfaces of the metal casing.

### CROSS REFERENCE TO RELATED APPLICATION(S)

This application claims the priority benefit of French Patent Application number 2311604, filed on Oct. 25, 2023, entitled “Module de Capteur Optique,” which is hereby incorporated by reference to the maximum extent allowable by law.

### TECHNICAL FIELD

The present disclosure relates generally to optical sensors, in particular optical sensor modules.

### BACKGROUND

Optical sensors, such as proximity sensors, may be used to detect the presence of nearby objects. Optical sensors are able to do so without physically touching the object. Some types of optical sensors, such as those utilized in optical ranging devices or time of flight sensors, may be used to determine the actual distance to such nearby objects. Optical sensors may be utilized in various electronic devices, such as cameras, phones, including smartphones, smartwatches, tablets, vehicles, machinery, and other devices for detecting the presence of and/or distance to nearby objects. After detecting the presence of the nearby object, the electronic device may be configured to perform a function, such as move a mechanical feature to a secure position, transmit an alarm signal, couple or uncouple an electrical communication, or any other desired function.

Optical sensors typically include components, such as a light-emitting device, a light-receiving sensor, and generally a processing device for processing signals received from the light-receiving sensor. The components of the optical sensor may be formed on a substrate, and a cap may be bonded to the substrate over the components, for example to protect them from damage, thereby forming an optical sensor module, also called optical sensor package. The cap is generally formed with a first opening located over the light-emitting device and a second opening located over the light-receiving sensor.

Generally described, the light-emitting device emits a light signal through the first opening. If an object is outside, and close enough to, the optical sensor module, the light signal may be reflected by the object towards the light-receiving sensor through the second opening. The light-receiving sensor may then generate an electrical signal indicative of the received light signal, which may be transmitted to the processing device for processing the received light signal, for example to determine the presence of, and/or distance to, the proximate object.

There is a need for improving optical sensor modules, in particular to address electronic magnetic interference (EMI) issues between an optical sensor module and another electronic device, for example an electronic device that incorporates the optical sensor module.

### BRIEF SUMMARY

One embodiment addresses all or some of the drawbacks of known optical sensor modules.

One embodiment provides an optical sensor module comprising:
a light-emitting device;
a light-receiving sensor;
a module cap adapted to at least partially cover the light-emitting device and the light-receiving sensor, the module cap comprising a metal casing and a molded part made of a molding material lining the inside surfaces of the metal casing.

In one embodiment, the metal of the metal casing is selected to reflect and/or absorb electromagnetic waves, for example the metal is a metal, including an alloy, which has a good electrical conductivity, and preferably a good magnetic permeability, for example copper, a copper alloy, brass, or a stainless steel.

In one embodiment, the molded part is an injection molded part.

In one embodiment, the molding material is a plastic, a resin, a liquid crystal polymer or another engineering plastic.

In one embodiment, the molded part comprises electrically conductive particles dispersed within the molding material.

In one embodiment, the metal casing is positioned outside the molded part, for example the metal casing covers the molded part such that the molded part is contained within the metal casing.

In one embodiment, the metal casing is embedded within the molded part.

In one embodiment, the optical sensor module further comprises a substrate to which the module cap is assembled, wherein the metal casing is electrically coupled to the ground through the substrate, for example through a first conductive pad of the substrate, for example using a conductive solder or a conductive adhesive, such as a silver epoxy.

In one embodiment, the optical sensor module further comprises a conductive lead assembled with, or included in, the module cap, and electrically coupled to the substrate, for example through a second conductive pad.

In one embodiment, the module cap comprises a first opening located over the light-emitting device and a second opening located over the light-receiving sensor, the first and second openings each passing through the metal casing and the molded part.

In one embodiment, the optical sensor module further comprises a glass, for example a lens, positioned in the first opening, or between the first opening and the light-emitting device, and adapted to transmit light signals emitted by the light-emitting device, the glass including a conductive trace coupled to the conductive lead.

In one embodiment, the molded part includes a separation wall between the light-emitting device and the light-receiving sensor.

One embodiment provides a method of fabricating an optical sensor module, the method comprising:
forming a metal casing;
injecting a molding material at least inside the metal casing to form a molded part lining the inside surfaces of the metal casing; the metal casing and the molded part forming a module cap; and
placing the module cap over a light-emitting device and a light-receiving sensor.

In one embodiment, the metal casing is formed using a subtractive, additive, or forming manufacturing method.

In one embodiment, the light-emitting device and the light-receiving sensor are positioned on a substrate, and placing the module cap over the light-emitting device and the light-receiving sensor comprises assembling the module cap to the substrate and electrically coupling the metal casing to the ground through the substrate, for example through a first conductive pad of the substrate.

In one embodiment, injecting the molding material comprises placing the metal casing on a core tool of a molding tool.

In one embodiment, injecting the molding material further comprises injecting the molding material outside the metal casing in order the molded part to embed the metal casing.

In one embodiment, injecting the molding material outside the metal casing comprises placing a cavity tool of the molding tool over the metal casing and the core tool, and injecting the molding material around the metal casing to form the molded part.

### BRIEF DESCRIPTION OF DRAWINGS

The foregoing features and advantages, as well as others, will be described in detail in the following description of specific embodiments given by way of illustration and not limitation with reference to the accompanying drawings, in which:

FIG. 1A is a 3-dimensional view of an optical sensor module according to an embodiment;

FIG. 1B is a sectioned 3-dimensional view of the optical sensor module of FIG. 1A;

FIG. 2A is a 3-dimensional view of an optical sensor module according to another embodiment;

FIG. 2B is a sectioned 3-dimensional view of the optical sensor module of FIG. 2A;

FIG. 3A, FIG. 3B, FIG. 3C and FIG. 3D are 3-dimensional views illustrating an example of method of fabricating the optical sensor module of FIGS. 2A and 2B;

FIG. 4A is a sectioned 3-dimensional view of an optical sensor module according to another embodiment;

FIG. 4B is a 3-dimensional view of the substrate of the optical sensor module of FIG. 4A;

FIG. 4C is a 3-dimensional view of a detail of the optical sensor module of FIG. 4A;

FIG. 5A, FIG. 5B and FIG. 5C are 3-dimensional and cross-section views illustrating an example of method of fabricating the optical sensor module of FIGS. 4A to 4C.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail. In particular, all the components of an optical sensor have not been detailed, the described embodiments being compatible with the usual optical sensors. For example, the light-emitting device, the light-receiving sensor, and other components of an optical sensor, such as a processing device or circuit, have not been detailed. Similarly, all the components of an optical sensor module have not been detailed, the described embodiments being compatible with the usual optical sensor modules.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures, or to an optical sensor module as orientated during normal use.

Unless specified otherwise, the expressions “around”, “approximately”, “substantially” and “in the order of” signify within 10%, and preferably within 5%.

In the following disclosure, unless indicated otherwise, when reference is made to a glass, this includes an element made of a material which is relatively transparent to light at the wavelengths used, for example has a transmission rate of 90 percent or more for these wavelengths. This includes, without being limited to, a glass material or plastic material. The glass may be formed of a solid single material, or may be formed by assembling multiple materials, in which case only part of the glass may be in a transparent material. The glass may comprise, or consist in, a lens or a plurality of lenses, and/or an optical filter. The glass may be referred to as an optic.

In the following disclosure, unless indicated otherwise, when reference is made to a filter, reference is made to an optical filter.

In the following disclosure, unless indicated otherwise, when reference is made to a conductive element, reference is made to an electrically conductive element.

In the present disclosure, unless indicated otherwise, when reference is made to a component, reference is made to an electronic component.

The term “optical sensor module” includes, without being limited to, a proximity sensor module, a time of flight (ToF) module, an ambient light sensor (ALS) module, a 3D Lidar module, and/or a camera module. The term optical sensor module also includes an optical sensor module with combined functions, for example a combination of at least two of the above-mentioned modules, or other functions, for example a combination of a proximity detector module with a floodlight and/or a dot projector.

The embodiments relate to optical sensor modules. An optical sensor typically includes a light-emitting device, for example a light emitting diode (LED), or a laser such as a vertical cavity surface emitting laser (VCSEL), and a light-receiving sensor, such as a photodiode or a plurality of photodiodes. An optical sensor generally also includes a processing device for processing signals received from the light-receiving sensor. The light-emitting device and the light-receiving sensor may be formed on a substrate, for example each in a different die or interposer attached to the substrate, and a cap may be bonded to the substrate over the light-emitting device and the light-receiving sensor, thereby forming an optical sensor module, also called optical sensor package. The cap is generally formed with a first opening located over the light-emitting device and a second opening located over the light-receiving sensor.

The optical sensor module may be affected by electromagnetic interferences (EMI) with another electronic device.

For example, when the optical sensor module is included in an electronic device (host device), electromagnetic interferences (EMI) may occur between the optical sensor module and other components in the host device. The electronic device may be a camera, a phone, for example a smartphone, a smartwatch, a tablet, a vehicle, a machinery, or another device for which an optical sensor may be useful for interactions with the surrounding or nearby objects.

The electromagnetic interferences between the optical sensor module and the host device may comprise:
electromagnetic waves emitted by components of the optical sensor module which may affect components of the host device; and/or
electromagnetic waves emitted by the host device which may affect the performance of the optical sensor module.

In addition, environments, such as environments having excessive radiated electromagnetic waves, for example data centres, may also interfere with components of the optical sensor module and affect its performance.

One solution to address the electromagnetic interference issues is to assemble one, or more, metal shield over the electromagnetic sensitive components of the optical sensor module.

However, such a metal shield over the electromagnetic sensitive components may have a certain number of drawbacks. Using a metal shield takes up space in the optical sensor module, and it thus can increase the footprint of the optical sensor module. Depending on the method used, the fabrication of the metal shield may introduce a large number of steps, such as assembling steps, which can induce high production costs. In addition, assembly generally needs large apertures, for example to take into account assembly tolerance, which are generally larger than for other techniques, such as in molding techniques, and may lead to larger metal openings for optical paths. Therefore, the metal shield assembled over the electromagnetic sensitive components can be problematic for small optical sensor modules. Besides, the EMI shielding performance of the metal shield may not be uniform depending on the way the metal shield is designed and assembled to the components. Moreover, there may be difficulties to implement a grounding scheme on the metal shield.

The inventors propose an optical sensor module making it possible to overcome all or part of the aforementioned drawbacks, in particular to address the electromagnetic interference issues, using an efficient and simple solution which can avoid increasing the footprint of the optical sensor module.

Embodiments of optical sensor modules will be described below. These embodiments are non-limiting and various variants will appear to the person skilled in the art from the indications of the present description.

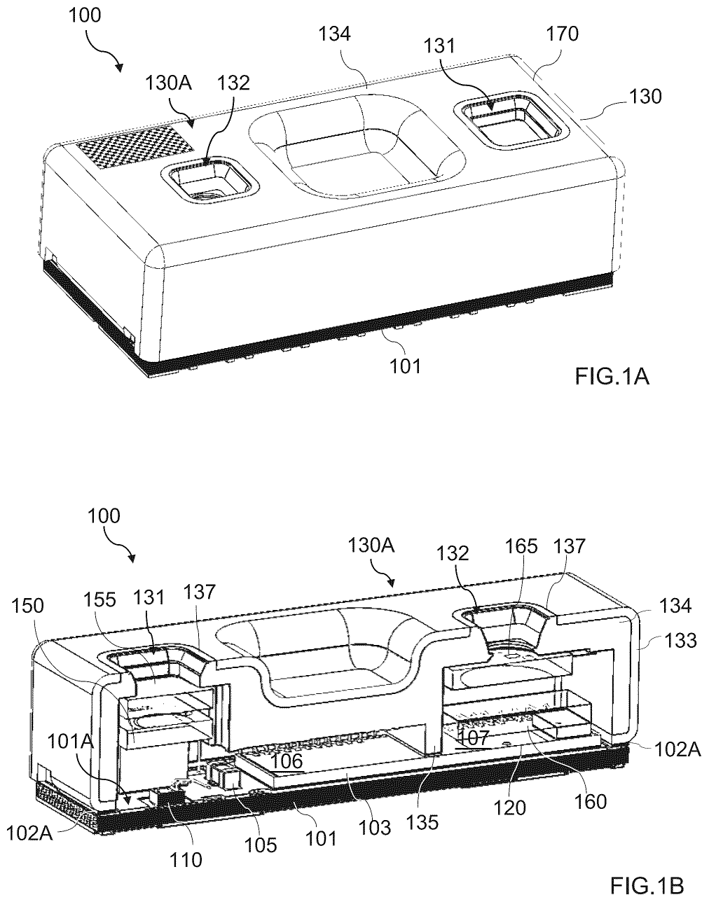

FIG. 1A is a 3-dimensional view of an optical sensor module 100 according to an embodiment. FIG. 1B is a sectioned 3-dimensional view of the optical sensor module of FIG. 1A. The module in FIG. 1B is rotated 180 degrees around a vertical axis relative to the optical sensor module in FIG. 1A. The sectioned view of FIG. 1B shows the optical sensor module cut to about half its width, and makes it easier to see the different components of the optical sensor module.

The optical sensor module 100 comprises a light-emitting device 110, for example comprising a LED such as an infrared LED, and/or a laser such as a VCSEL or an Edge Emitting Laser (EEL), and a light-receiving sensor 120, or image sensor, for example comprising a photodiode or a plurality of photodiodes, such as SPAD(s), the light-emitting device 110 and the light-receiving sensor 120 being formed over a substrate 101. The light-emitting device 110 may comprise a plurality of light sources.

The substrate 101 may be a printed circuit board (PCB).

The light-emitting device 110 is configured to emit light signals at a particular frequency or frequency range, and the light-receiving sensor 120 is adapted to detect the emitted light signals in return, for example reflected by an object. In one embodiment, the light-emitting device 110 is configured to emit infrared (IR) light signals, and the light-receiving sensor 120 is adapted to detect the IR light signals in return, for example reflected by an object.

The optical sensor module 100 may comprise a driver 103, for example a laser driver, configured for controlling the light-emitting device 110. The driver 103 may be mounted on a top surface 101A of the substrate 101.

The optical sensor module 100 may comprise a processing circuit (not represented in FIGS. 1A and 1B) for processing light signals emitted by the light-emitting device 110 and received by the light-receiving sensor 120.

The optical sensor module 100 includes other electrical circuits, or components, such as surface mounted technology (SMT) components 105 which are also mounted on the top surface 101A of the substrate 101. The SMT components 105 may comprise resistors. Other SMT components may comprise capacitors.

A module cap 130 having a first opening 131 and a second opening 132 is assembled to the substrate 101 and is adapted to at least partially enclose, or cover, the components which are mounted on the substrate 101, at least the light-emitting device 110, the light-receiving sensor 120, the laser driver 103, and the SMT components 105. At least partially means that all the components may be not covered, for example the first and second openings do not cover the components which are under the openings. The module cap 130 may be substantially opaque to light at the wavelengths used. The first opening 131 is located over the light-emitting device 110 and the second opening 132 is located over the light-receiving sensor 120. In the illustrated example, the first and second openings are rectangular, or even square, but this is not limitative and other forms are possible.

The module cap 130 comprises a metal casing 133 and a molded part 134, for example a resin molded part, lining the inside surfaces of the metal casing, for example completing an integrated module cap component.

With an electrically insulating molded part 134, the inner walls of the module cap 130 are insulated, therefore, the internal components of the optical sensor module are electrically insulated against the metal casing 133 and are protected against the possibility of being electrically shorted to the metal casing 133. The inside surfaces mean the surfaces which are inside the optical sensor module 100, or under the module cap 130.

In addition, the inner molded part 134 may allow for sufficient optical properties to be used on the inner walls of the module cap 130, for example to prevent unwanted reflections within this module cap which would otherwise likely occur from a metal casing 133.

Moreover, the inner molded part 134 may be advantageously molded using an injection molding technique, which allows high precision and the ability to make complex shapes, for example support parts such as support planes on which components such as optical components can be mounted.

The metal casing 133, which may also be designated as a metal can, is in contact with the molded part 134. In other words, there is no gap between the metal casing 133 and the molded part 134. The shape of the molded part 134 conforms to the shape of the metal casing 133.

The first and second openings 131, 132 are located at the top face 130A of the module cap 130, and pass through the metal casing 133 and the molded part 134.

The metal of the metal casing 133 is preferably selected to reflect and/or absorb electromagnetic waves generated by another electronic device, such as a host device, or electromagnetic waves coming from the environment, to prevent the electromagnetic waves from affecting the performance of the optical sensor module.

The metal of the metal casing 133 may also be selected to reflect and/or absorb electromagnetic waves generated by the optical sensor module to prevent the electromagnetic waves from exiting the optical sensor module and for example affecting the host device.

The metal of the metal casing 133 is for example copper, a copper alloy, brass, stainless steel, or any other metallic material, including alloys, having good electrical conductivity, and preferably good magnetic permeability. The metal is preferably selected based on the shielding and module design requirements.

The molded part 134 is made of a molding material, which may for example be a plastic, a resin, a liquid crystal polymer (LCP), or another engineering plastic. The molded part 134 may be formed using an injection molding process. The molded part 134 may be compounded with electrically conductive particles dispersed within the molding material.

The molded part 134 may be designed to form a separation wall 135 between the light-emitting device 110 and the light-receiving sensor 120. The separation wall 135 may form an optical isolator for substantially preventing the internal propagation of light beams between the light-emitting device 110 and the light-receiving sensor 120 within the module cap 130. For example, the separation wall 135 may define first and second cavities 106, 107, the first cavity 106 including the first opening 131 above the light-emitting device 110, and the second cavity 107 including the second opening 132 above the light-receiving sensor 120.

The laser driver 103 may be located in the first cavity 106, together with the light-emitting device 110, and the processing circuit may be located in the second cavity 107, together with the light-receiving sensor 120.

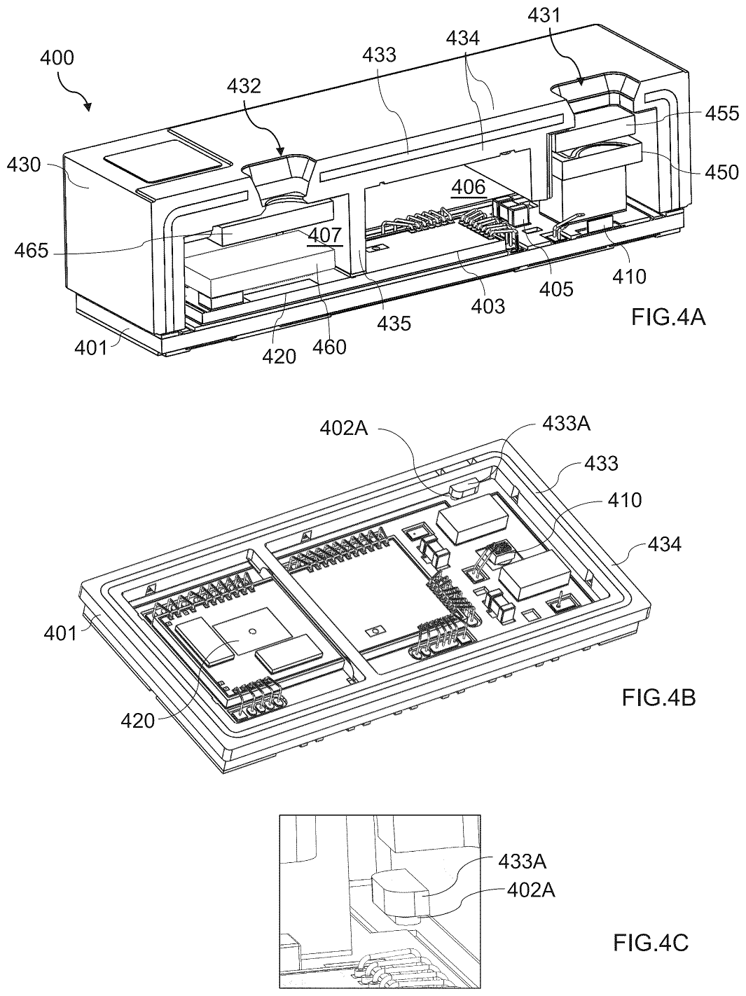

In the embodiment of FIGS. 1A and 1B, the metal casing 133 is positioned outside the molded part 134, and may preferably cover or envelop the molded part, such that the molded part is contained, and molded, inside the metal casing. Other configurations are possible. For example, the metal casing may be embedded in the molded part, such as described hereafter in relation with FIGS. 4A to 4C.

The metal casing may be the to be overmold by the molded part. The overmolding technique refers to a molding process, generally an injection molding process, which results in a seamless combination of multiple materials into a single part or piece. The product of the overmolding method relative to the module cap 130 is a single integrated component consisting of the metal casing 133 and the molded part 134.

The metal casing provides EMI protection to the optical sensor module. The fact that the metal casing is part of the module cap, and thus at least partially encloses, or covers, the components of the optical sensor module, makes it efficient to protect these components, without increasing the footprint of the optical sensor module.

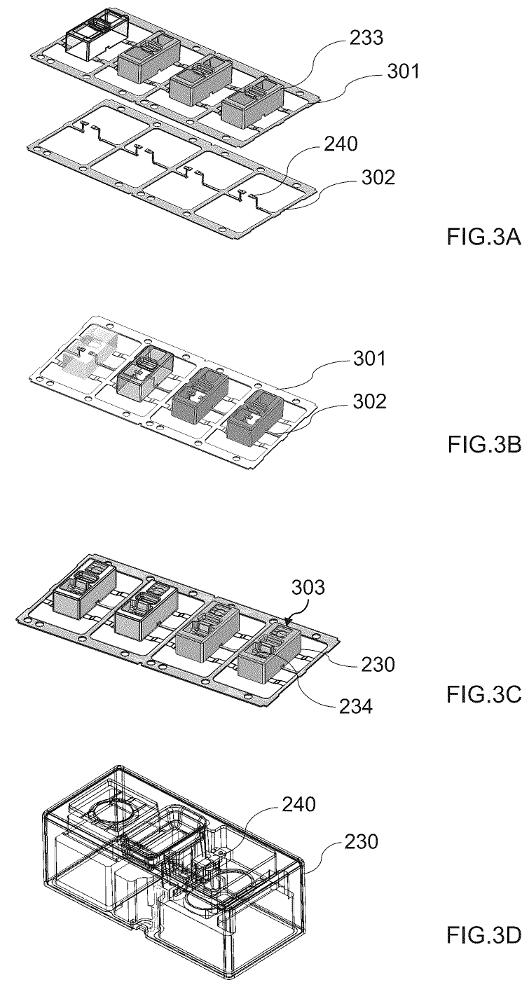

The metal casing may be formed using a stamping technique, for example as described hereafter in relation with FIGS. 3A to 3D, or a machining technique. The molded part may be molded inside the metal casing, such that the metal casing is overmold.

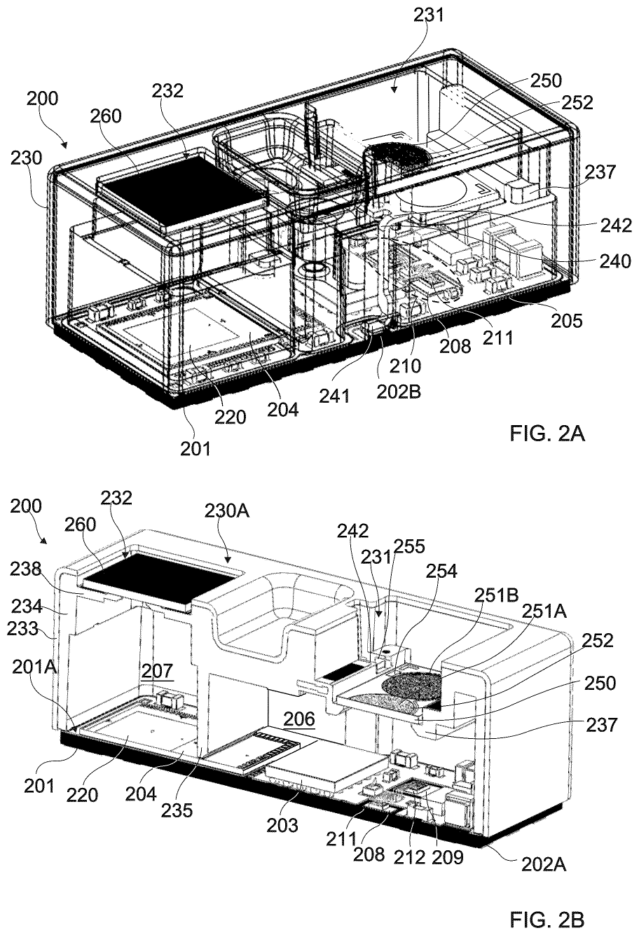

In the embodiment of FIGS. 1A and 1B, the first and second openings 131, 132 of the module cap 130 comprise upper edges 137 made of the molding material which are flush with the top face 130A of the module cap 130. Thus, the metal of the metal casing 133 does not go all the way to the upper edges 137 of the first and second openings. Other configurations are possible, for example configurations in which the metal of the metal casing goes all the way to the upper edges of the first and second openings, that is, covers the upper edges of the first and second openings, such as described hereafter in relation with FIGS. 2A and 2B. The configuration may depend on design requirements, for example if minimizing the openings of the metal casing for a better shield is desired, and/or to reach a desired precision and position of these openings.

To assemble the module cap 130 to the substrate 101, the metal casing 133 may be attached to the substrate 101, for example using a conductive solder or a conductive adhesive, for example a silver epoxy.

The metal casing 133 is preferably grounded to further improve the effectiveness of EMI protection, for example to make the EMI protection performance uniform and easily controlled. For example, the substrate 101 may comprise a first conductive rail (not shown in FIGS. 1A and 1B) configured to be at the ground, and the metal casing 133 may be coupled, for example connected, to the first conductive rail of the substrate. The metal casing 133 may be attached to the substrate 101, and coupled to the first conductive rail, for example through conductive pads 102A (first conductive pads) on the substrate, using a conductive solder or a conductive adhesive, for example a silver epoxy.

The optical sensor module 100 further comprises in the first cavity 106:
a glass 155, or optic, for example a filter, positioned in the first opening 131, or between the first opening 131 and the light-emitting device 110, and adapted to transmit the light signals emitted by the light-emitting device; and
a glass 150, or optic, for example a lens or a lens pad, positioned between glass 155 and the light-emitting device 110, and adapted to transmit the light signals emitted by the light-emitting device.

The glass 155, if included, preferably covers the first opening 131. The glass 155 is preferably attached to the module cap 130. For example, the glass 155 is mounted inside the module cap 130. In a variant, the glass 155 could be mounted outside the module cap.

The glass 150 may comprise an optical surface which may be a beam shaper over the light-emitting device 110. The glass 150 may comprise a conductive trace, which may be embedded in this glass.

The optical sensor module 100 further comprises in the second cavity 107:
a glass 165, or optic, which is a lens in the represented example, positioned in the second opening 132, or between the second opening 132 and the light-receiving sensor 120, and adapted to transmit the light signals reflected towards the light-receiving sensor; and
a glass 160, or optic, which is a filter in the represented example, positioned between the lens 165 and the light-receiving sensor 120.

The lens 165 preferably covers the second opening 132. The lens 165 is preferably attached to the module cap 130. For example, the lens 165 is positioned inside the module cap 130. In a variant, the lens 165 could be mounted outside the module cap.

FIG. 2A is a 3-dimensional view of an optical sensor module 200 according to another embodiment. FIG. 2B is a sectioned 3-dimensional view of the optical sensor module of FIG. 2A. The sectioned view of FIG. 2B shows the optical sensor module cut to about half its width, and makes it easier to see the different components of the optical sensor module.

Similarly to the optical sensor module 100 of FIGS. 1A and 1B, the optical sensor module 200 of FIGS. 2A and 2B comprises a light-emitting device 210, a light-receiving sensor 220, a laser driver 203, a processing circuit 204, and SMT components 205 mounted on a top surface 201A of a substrate 201, and a module cap 230 assembled to the substrate 201 and adapted to at least partially enclose, or cover, the components which are mounted on the substrate 201. The module cap 230 comprises a metal casing 233 and a molded part 234 lining the inside surfaces of the metal casing. A first opening 231 and a second opening 232 are located at a top face 230A of the module cap 230, respectively over the light-emitting device 210 and over the light-receiving sensor 220. The molded part 234 may be designed to form a separation wall 235 between the light-emitting device 210 and the light-receiving sensor 220, defining first and second cavities 206, 207, the first cavity 206 including the first opening 231 above the light-emitting device 210 and the laser driver 203, and the second cavity 207 including the second opening 232 above the light-receiving sensor 220 and the processing circuit 204.

Contrary to the metal casing 133 of FIGS. 1A and 1B, the metal casing 233 of FIGS. 2A and 2B covers the upper edges of the first and second openings 231, 232 of the module cap 230. In other words, the metal of the metal casing goes all the way to the edges of the first and second openings.

The light-emitting device 210 of FIGS. 2A and 2B comprises first and second light sources 211, 212. Each of the first and second light sources may be mounted on respectively a first interposer 208 and a second interposer 209, the first and second interposers 208, 209 being mounted on a top surface 201A of the substrate 201. Other configurations exist, without interposers. The first and second light sources 211, 212 are for example first and second VCSELs.

The optical sensor module 200 of FIGS. 2A and 2B comprises:
a lens 250, or glass, positioned in the first opening 231, or between the first opening 231 and the light-emitting device 210, and adapted to transmit the light signals emitted by the light-emitting device 210; and
a filter 260, positioned in the second opening 232, or between the second opening 232 and the light-receiving sensor 220, and adapted to transmit the light signals reflected towards the light-receiving sensor 220.

The lens 250 preferably covers the first opening 231. The lens 250 is preferably attached to the module cap 230. For example, the lens 250 sits on a first mounting 237 which is formed within the first opening 231, and is mounted outside the module cap 230. In a variant, the lens 250 could be mounted inside the module cap.

Similarly, the filter 260 preferably covers the second opening 232. The filter 260 is preferably attached to the module cap 230. For example, the filter 260 sits on a second mounting 238 which is formed within the second opening 232, and is mounted outside the module cap 230. In a variant, the filter 260 could be mounted inside the module cap.

The lens 250 may comprise two optical surfaces which may be two beam shapers: a first beam shaper 251A located over the first light source 211, and a second beam shaper 251B located over the second light source 212. The lens 250 may be a lens pad.

The lens 250 includes a conductive trace 252, which may be embedded in this lens. The lens 250 may further include conductive pads 254 (third conductive pads) coupled to the conductive trace 252, for example two conductive pads 254, each at an end of the conductive trace.

The conductive traces may be called “traces” in the following disclosure. The conductive pads may be called “pads” in the following disclosure.

Examples of conductive trace are described in more detail in the French patent application number 2311561, filed on Oct. 25, 2023 in the name of STMICROELECTRONICS INTERNATIONAL N.V. (law firm reference being B22689), which is hereby incorporated by reference to the maximum extent allowable by law.

The optical sensor module 200 of FIGS. 2A and 2B could alternately comprise, like the optical sensor module 100 of FIGS. 1A and 1B, the lens 250 and another glass, for example a filter, in the first cavity, and the filter 260 and another glass, for example a lens, in the second cavity. More generally, other variants may be encompassed by a person skilled in the art.

The optical sensor module 200 of FIGS. 2A and 2B also mainly differs from the optical sensor module 100 of FIGS. 1A and 1B in that it comprises conductive leads 240 assembled to the module cap 230. For example, the conductive leads 240 may be configured and positioned in order to electrically couple the conductive trace 252 of the lens 250 to the substrate 201. Conductive leads 240 are for example lead frames. Conductive leads 240 are for example metal leads. Each conductive lead 240 may be a single conductive piece, for example a single metallic piece. Each conductive lead 240 may be inserted into recesses, or channels, formed in the module cap 230.

Each conductive lead 240 comprises a first end 241 coupled, for example connected, to the substrate 201 through a conductive pad 202B (second conductive pad) on the substrate, and a second end 242 coupled, for example connected, to the conductive trace 252 through one of the conductive pads 254 of the lens 250. The first end 241 of each conductive lead 240 may be coupled to the conductive pad 202B by a conductive adhesive material or a conductive solder. The second end 242 of each conductive lead 240 may be coupled to the conductive pad 254 of the lens 250 by a conductive wire 255 formed by wire bonding, which may be called a “wire bond”.

Examples of conductive wire are described in more detail in the French patent application number 2311572, filed on Oct. 25, 2023 in the name of STMICROELECTRONICS INTERNATIONAL N.V. (law firm reference being B22688) entitled “Module de Capteur Optique”, which is hereby incorporated by reference to the maximum extent allowable by law.

The conductive trace 252 within the lens 250 can provide a complementary EMI shielding for the optical sensor module in the openings of the module cap, for example in the first opening 231 of the module cap 230, for example by providing EMI reflection in the first opening. Advantageously, the conductive trace is grounded, for example through at least one of the conductive leads 240, and then through the substrate.

Alternately, when the lens 250 is used as a diffuser suitable for reducing to some extent the intensity of a light beam emitted by the light-emitting device 210, for example for safety reasons, such as protecting a user, the conductive trace 252 may be used to detect whether the lens 250 is detached, broken, or otherwise removed from over the light-emitting device 210, for example to avoid exposing a user to the full intensity of the light beam. The conductive trace 252 may then be arranged to be coupled to a second conductive rail of the substrate 201 configured to be at a fixed voltage, for example at the ground, using at least one of the conductive leads 240. The second conductive rail may be the first conductive rail described in relation with FIGS. 1A and 1B and may be at the ground.

FIG. 3A, FIG. 3B, FIG. 3C and FIG. 3D are 3-dimensional views illustrating an example of method of fabricating the optical sensor module 200 of FIGS. 2A and 2B.

FIG. 3A shows a first stripe 301 comprising a plurality, four in the illustrated example, of formed metal casings 233, which may be similar to the metal casing of FIGS. 2A and 2B, and a second stripe 302 comprising a plurality, four in the illustrated example, of formed pairs of conductive leads 240, which may be similar to the conductive leads of FIGS. 2A and 2B, for example metal leads. Each stripe may be formed using a stamping technique. Each pair of conductive leads 240 is aligned with one of the metal casings 233, and is positioned in order to be inside the metal casing, but not in contact with the metal casing.

FIG. 3B shows the assembly of the first stripe 301 with the second stripe 302, for example using a welding technique or a riveting technique.

FIG. 3C shows a structure obtained after an injection molding process, in which a molding material is injected inside the metal casings 233 to form the molded parts 234 of the module caps 230, which may be similar to the module cap of FIGS. 2A and 2B.

FIG. 3D shows a structure obtained after having cut the structure of FIG. 3C in order to separate, or singulate, each module cap 230 from each other.

Then, each module cap 230 may be assembled to a substrate, and coupled to electronic components and circuits, in order to form an optical sensor module. For example, the metal casing 233 may be electrically coupled to the substrate, for example through a conductive pad 202A (first conductive pad) of the substrate.

The method could be adapted to the optical sensor module 100 of FIG. 1A and 1B, without the second stripe and without the assembly step with the first stripe.

FIG. 4A is a sectioned 3-dimensional view of an optical sensor module 400 according to another embodiment. FIG. 4B is a 3-dimensional view of the substrate of the optical sensor module of FIG. 4A. FIG. 4C is a 3-dimensional view of a detail of the optical sensor module of FIG. 4A. The sectioned view of FIG. 4A shows the optical sensor module cut to about half its width.

Similarly to the optical sensor module 100 of FIGS. 1A and 1B, the optical sensor module 400 of FIGS. 4A to 4C comprises a light-emitting device 410, a light-receiving sensor 420, a laser driver 403, processing circuits, and SMT components 405 mounted on a top surface of a substrate 401, and a module cap 430 assembled to the substrate and adapted to at least partially enclose, or cover, the components which are mounted on the substrate, the module cap 430 comprising a metal casing 433 and a molded part 434. A first opening 431 and a second opening 432 are located at a top face of the module cap 430, respectively over the light-emitting device 410 and over the light-receiving sensor 420. The molded part 434 of the module cap 430 may include a separation wall 435 between the light-emitting device 410 and the light-receiving sensor 420, defining first and second cavities 406, 407, the first cavity 436 including the first opening 431 above the light-emitting device 410 and the laser driver 403, and the second cavity 407 including the second opening 432 above the light-receiving sensor 420 and the processing circuits.

Similarly to the optical sensor module 100 of FIGS. 1A and 1B, the optical sensor module 400 further comprises:
an optional filter, 455, positioned in the first opening 431, or between the first opening 431 and the light-emitting device 410;
a lens 450, positioned between the filter 455 and the light-emitting device 410, and adapted to transmit the light signals emitted by the light-emitting device;
a lens 465, positioned in the second opening 432, or between the second opening 432 and the light-receiving sensor 420; and
a filter 460, positioned between the lens 465 and the light-receiving sensor 420.

The lens 450 and/or the lens 465 may include an optical surface which may be a beam shaper, and/or may include a conductive trace which may be embedded in the lens.

The optical sensor module 400 mainly differs from the optical sensor module 100 of FIGS. 1A and 1B or from the optical sensor module 200 of FIGS. 2A and 2B in that the molded part 434 lines the inside and outside surfaces of the metal casing. In other words, the metal casing 433 is not positioned outside the module cap 430, but is embedded in the molded part 434. The metal casing 433 is advantageously not directly exposed to the external of the optical sensor module 400. If the molded part 434 is made of an isolating material, the main part of the embedded metal casing 433 may then be isolated from the external of the optical sensor module 400 by the molded part.

The molded part 434 is for example molded around the metal casing 433 with no gap between the metal and the molding material of the molded part.

The metal casing 433 is preferably grounded to further improve the effectiveness of EMI protection. For example, the substrate 401 may comprise conductive pads 402A (first conductive pads) configured to be at the ground, and the metal casing 433 may be coupled, for example connected, to the conductive pads 402A. The metal casing 433 may comprise a metal extension 433A extending beyond the molded part 434 and attached to the substrate 401 through the conductive pads 402A, for example using a conductive solder or a conductive adhesive, for example a silver epoxy.

The shape of the molded part 434 may conform to the shape of the metal casing 433.

The metal casing 433, being part of the module cap 430, can at least partially enclose, or cover, the components which are mounted on the substrate 401, in order to protect these components from EMI.

The molded part 434, which is made of a molding material, for example an injected molding material, with the metal casing inside may provide a structure suitable for optical needs and/or for handling or assembly requirements.

The module cap 430 may be assembled to the substrate using an adhesive, for example an opaque adhesive, for example positioned on edges of the substrate 401.

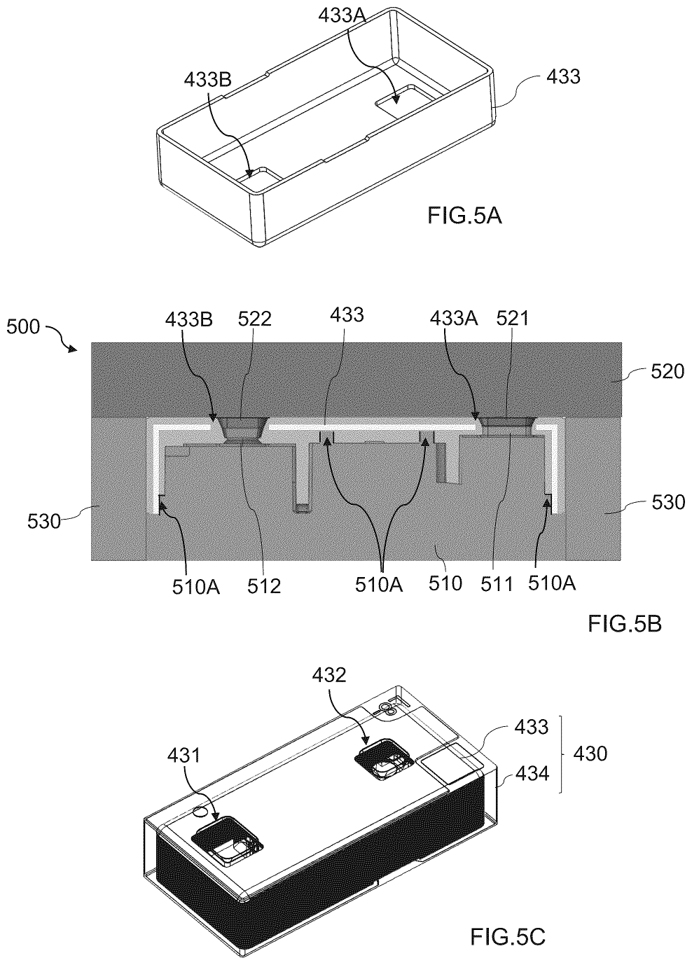

FIG. 5A, FIG. 5B and FIG. 5C are 3-dimensional and cross-section views illustrating an example of method of fabricating the optical sensor module 400 of FIGS. 4A to 4C.

FIG. 5A is a 3-dimensional view representing a metal casing 433 with first and second openings 433A, 433B, corresponding to the first and second openings 431, 432 of the future module cap 430, similar to the metal casing of FIG. 4A. For example, the metal casing is formed using a stamping technique, for example using a stamping stripe as shown in FIG. 3A, and then cutting the stripe to form singulated metal casings. Alternately, the metal casing may be machined to produce relevant features.

FIG. 5B is a cross-section view representing an example of injection molding tool 500 comprising several parts adapted to enclose the metal casing 433 inside. The molding tool 500 comprises:
a core tool 510 on which the metal casing 433 can be placed;
a core insert 530 adapted to surround the core tool 510 and to define the edges of the future molded part 434 of the module cap 430;
a cavity tool 520 sitting on the core insert 530, and adapted to form the top side of the molded part 434.

The core tool 510 comprises:
first and second protrusion parts 511, 512 which are vertically in line with, one of them going through, respectively the first and second openings 433A, 433B of the metal casing 433; and
multiple protrusion features 510A to hold the metal casing 433 in position during the injection molding process.

The cavity tool 520 comprises, or is extended by, third and fourth protrusion parts 521, 522 which are vertically in line with, one of them going through, the first and second openings 433A, 433B of the metal casing 433, and vertically in line with the first and second protrusion parts 511, 512 of the core tool 510.

The shape and dimensions of the molding tool 500 may be adapted to define a thickness of the molding material injected under the metal casing 433, for example by defining a distance between the top face of the core tool 510 and/or the core insert 530 and the metal casing 433.

The protrusions parts 511, 512, 521, 522 are adapted to define the first and second openings 431, 432 of the future module cap 430, by defining parts in which the molding material will not be able to penetrate. The protrusions parts 511, 512, 521, 522 may also be adapted to define a thickness of the molding material injected over the metal casing 433, by defining a distance between the cavity tool 520 and the metal casing 433, and/or between the cavity tool 520 and the core part 510.

FIG. 5C shows a structure obtained after having injected the molding material around the metal casing 433, to form the molded part 434, and thus the module cap 430, and after having ejected the molding tool 500.

In the current embodiments, the metal casing may have a thickness range of 80 to 150 μm. This is a non-limiting range, and the metal casing thickness can be varied according to shielding requirements and design objectives.

The optical sensor module according to the embodiments, with a module cap comprising a metal casing and a molded part made of a molding material lining the inside surfaces of the metal casing, for example embedding the metal casing, provides a certain number of advantages: the metal casing provides EMI shielding, and the molded part of the module cap may provide optical functions, the assembly making the optical sensor module compact. The use of a metal casing allows avoiding increasing the footprint of the optical sensor module which can be compact, and it also allows compensating the molded part weakness. The metal casing can be easily grounded through the substrate. The described examples of fabrication methods show that the optical sensor module according to the embodiments can be easily formed without complexifying the fabrication method.

The embodiments with the metal casing on the outside provide mechanical protection of the optical sensor module, and may be manufactured using a less complex manufacturing process compared to the embodiments with the metal casing embedded within the molded part.

The embodiments with the metal casing embedded within the molded part have external walls which are optically less reflective compared to the embodiments with the metal casing on the outside, and may allow a reduction in external crosstalk between the first (transmitting) opening and the second (receiving) opening, which might be required depending on the module design function.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove.

1. An optical sensor module comprising:
a light-emitting device;
a light-receiving sensor; and
a module cap adapted to at least partially cover the light-emitting device and the light-receiving sensor, the module cap comprising a metal casing and a molded part made of a molding material lining one or more inside surfaces of the metal casing.

2. The optical sensor module of claim 1, wherein a metal of the metal casing is selected to reflect and/or absorb electromagnetic waves, including one of copper, a copper alloy, brass, or stainless steel.

3. The optical sensor module of claim 1, wherein the molded part is an injection molded part;
wherein the molding material is a plastic, a resin, a liquid crystal polymer or another engineering plastic; and
wherein the molded part comprises electrically conductive particles dispersed within the molding material.

4. The optical sensor module of claim 1, wherein the metal casing is positioned outside the molded part, including the metal casing covering the molded part such that the molded part is contained within the metal casing.

5. The optical sensor module of claim 1, wherein the metal casing is embedded within the molded part.

6. The optical sensor module of claim 1, further comprising a substrate to which the module cap is assembled, wherein the metal casing is electrically coupled to a ground through the substrate through a first conductive pad of the substrate using a conductive solder or a conductive adhesive.

7. The optical sensor module of claim 6, further comprising a conductive lead assembled with, or included in, the module cap, and electrically coupled to the substrate through a second conductive pad.

8. The optical sensor module of claim 1, wherein the module cap comprises a first opening located over the light-emitting device and a second opening located over the light-receiving sensor, the first and second openings each passing through the metal casing and the molded part.

9. The optical sensor module of claim 8, further comprising a glass positioned in the first opening, or between the first opening and the light-emitting device, and adapted to transmit light signals emitted by the light-emitting device, the glass including a conductive trace coupled to a conductive lead.

10. The optical sensor module of claim 1, wherein the molded part includes a separation wall between the light-emitting device and the light-receiving sensor.

11. A method of fabricating an optical sensor module, the method comprising:
forming a metal casing;
injecting a molding material at least inside the metal casing to form a molded part lining the one or more inside surfaces of the metal casing, wherein the metal casing and the molded part forming a module cap; and
placing the module cap over a light-emitting device and a light-receiving sensor.

12. The method of fabricating an optical sensor module of claim 11, wherein the metal casing is formed using a subtractive, additive, or forming manufacturing method.

13. The method of fabricating an optical sensor module of claim 11, wherein the light-emitting device and the light-receiving sensor are positioned on a substrate, and placing the module cap over the light-emitting device and the light-receiving sensor comprises assembling the module cap to the substrate and electrically coupling the metal casing to a ground through the substrate through a first conductive pad of the substrate.

14. The method of fabricating an optical sensor module of claim 11, wherein injecting the molding material comprises placing the metal casing on a core tool of a molding tool.

15. The method of fabricating an optical sensor module of claim 11, wherein injecting the molding material further comprises injecting the molding material outside the metal casing in order the molded part to embed the metal casing.

16. The method of fabricating an optical sensor module of claim 15, wherein injecting the molding material outside the metal casing comprises placing a cavity tool of a molding tool over the metal casing and a core tool, and injecting the molding material around the metal casing to form the molded part.
